(19) United States
(12) Patent Application Publication
(10) Pub. No.: US 2004/0207769 A1
(43) Pub. Date: Oct. 21, 2004

(54) Projection display device

(75) Inventors: Ming-Kuen Lin, Yunlin (TW); Cheng-Kuang Lee, Taipei (TW)

Correspondence Address: QUINTERO LAW OFFICE, 1617 BROADWAY, 3RD FLOOR, SANTA MONICA, CA, 90404, US

(73) Assignee: BENQ Corporation

(21) Appl. No.: 10/821,276

(22) Filed: Apr. 8, 2004

(30) Foreign Application Priority Data
Apr. 18, 2003 (TW) 92109110

(51) Int. Cl. G02F 1/1335

(52) U.S. Cl. 349/5

(57) ABSTRACT

A projection display device having a light source and a light pipe is disclosed. The light pipe is deviated from the optical axis of the light source a predetermined distance. Therefore, the distribution of lights with a virtual arc array, transmitted by the light pipe, is asymmetrical, to increase intensity and uniformity of the projection display device.

### BACKGROUND OF THE INVENTION

1. Field of the Invention

The present invention relates to a projection display device, and in particular to a projection display device using digital light processing (DLP) technology.

2. Description of the Related Art

LCD (liquid crystal display) projectors use LCD modules to modulate lights emitted by a light source. In order to project images accurately, the lights must be separated into red, green and blue ray, modulated separately, and then merged for projecting onto a screen.

LCD projectors are classified into two types, including a transmissible LCD and a reflective LCD, according to different liquid crystal panels.

Major components of a transmissible LCD projector includes liquid crystal panels and diachronic mirrors for separating and merging lights. The lights are emitted by a light source, separated into red, green and blue ray by a diachronic mirror, separately modulated by three liquid crystal panels, and merged by a prism, and then are projecting onto a screen.

FIG. 1 is a schematic diagram of a conventional reflective LCD projector. The most significant difference between a reflective LCD projector and a transmissible LCD projector is that the reflective LCD projector has a polarization beam splitter and different liquid crystal panels. In FIG. 1, lights are emitted by a light source 110, refracted by a reflector 120, separated by diachronic mirrors 130, projected onto polarization beam splitters 140, and then modulated and reflected back by reflective liquid crystal panels 150. Further, the lights are processed by the polarization beam splitters 140, merged by a prism 160, and then projected onto a screen through a projection lens 170.

In the optical system in the reflective projector, a lens module is used to gather the lights of the light source, and generate parallel and uniform rays to be projected on the screen. Currently, improving the uniformity of the projected lights without altering the hardware architecture of the projector is a major problem to be solved for a DLP projector.

### SUMMARY OF THE INVENTION

Accordingly, an object of the present invention is to provide a projection display device having a light source and a light pipe is disclosed. The light pipe is deviated from the optical axis of the light source a predetermined distance. Therefore, the distribution of lights with a virtual arc array, transmitted by the light pipe, is asymmetrical, to increase intensity and uniformity of the projection display device.

Accordingly, the present invention provides a projection display device having an optical system. The optical system has a light source, a light pipe, a lens module, a digital micro-mirror device (DMD) and a projection plane. An optical axis of the light source is defined along a first direction and the light pipe is non-coaxially disposed with the optical axis. That is, the light pipe is deviated from the optical axis by a predetermined distance in a second direction perpendicular to the first direction. The light pipe receives lights with a virtual arc array from the light source, and transmits lights asymmetrically.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a conventional reflective LCD projector;

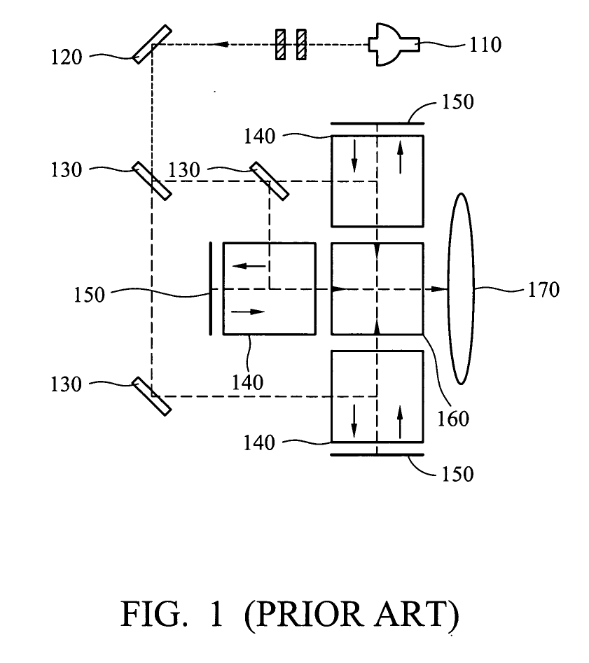

FIG. 2 is a schematic diagram of a reflective LCD projector of the present invention;

FIG. 3A˜3B are schematic diagrams showing paths of reflecting lights with different reflecting angles according to the present invention;

FIG. 4 is a schematic diagram of light symmetrically projected to form a virtual arc array by a light pipe of a conventional reflective projector; and

FIG. 5 is a schematic diagram of light projected asymmetrically to form a virtual arc array by a light pipe of a reflective projector of the present invention.

### DETAILED DESCRIPTION OF THE INVENTION

The present invention provides a projection display device for projecting light asymmetrically.

The present invention provides a DLP projector, which lights are reflecting via micro-reflectors on a DMD chip.

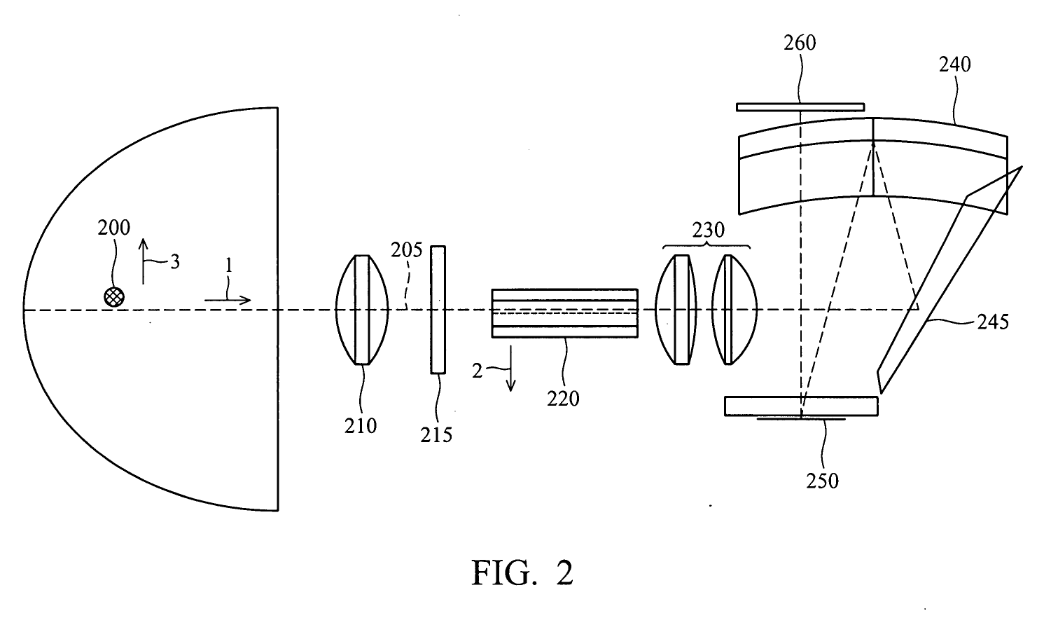

FIG. 2 is a schematic diagram of a reflective DLP LCD projector of the present invention. The projector has a optical system, and the optical system comprises a light source 200, a focusing lens 210, a color wheel 215, a light pipe 220, a lens module 230, a first reflector 240, a second reflector 245, a DMD (Digital Micro-mirror Device) 250, and a projection screen 260. The light source 200 emits lights along a first direction 1 to define an optical axis 205. The light pipe 220 is non-coaxially disposed with the optical axis 205.

The first direction 1, the second direction 2 and the third direction 3 are defined as follows. The direction 1 is parallel to an axis on a XY-plane where the light source 200 is positioned thereon, the second and third directions 2 and 3 are perpendicular to the first direction 1, that is, the second and third directions 2 and 3 are corresponding to the Z-axis. There are two methods to deviate the light pipe 220 from the light source 200 a predetermined distance. One is to shift the light source 200 toward the third direction 3 so as to deviate from the optical axis 205 by the predetermined distance, and the other is to shift the light pipe 220 toward the second direction 2 so as to deviate from the optical axis 205 by the predetermined distance. That is to say, the light pipe 220 deviate oppositely from the light source 200. The predetermined distance is substantially between 0.3 and 0.7 mm.

In this embodiment, a convergent lens 210 is positioned between the light source 200 and the light pipe 220, and focuses the lights from the light source 200. After filtering by the color wheel 215 having RGB filters, the lights are received by and passes through the light pipe 220. The lens module 230 then receives the focused and filtered lights, and outputs the focused and filtered lights uniformly. In addition, the lens module 230 transmits lights with a virtual arc array asymmetrically. The output lights are then reflected by the second reflecting lens 245 and the first reflecting lens 240 to the DMD 250. The second reflecting lens 245 and the first reflecting lens 240 are relay lens. The DMD 250 has many reflecting mirrors, by adjusting the directions of selected mirrors, images caused by the lights transmitted out of the lens module 230 can be shown in the screen 260 or be vanished from the screen 260, that is so called image on-off status. The image on-off status is described as follows.

(1) An Image is Formed (On Status):

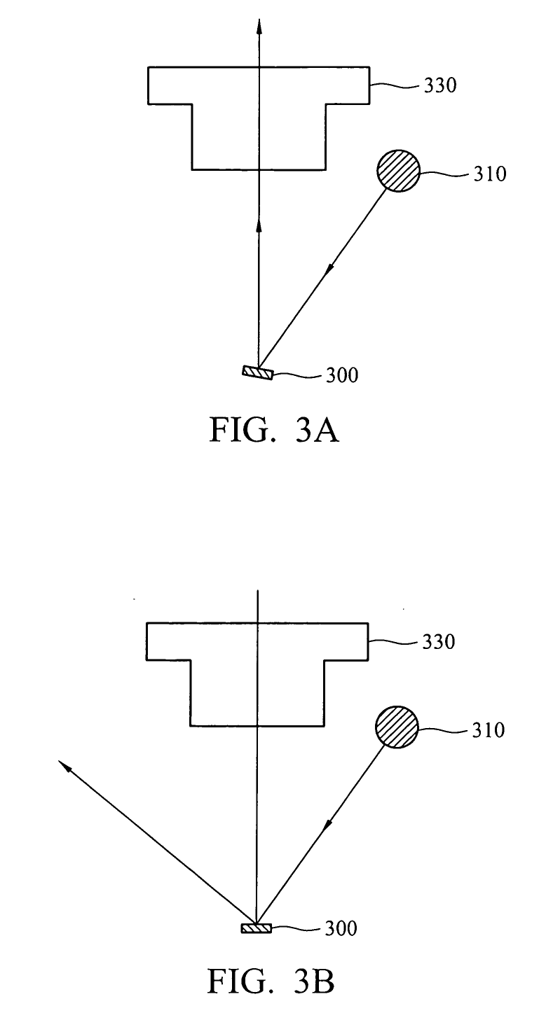

Referring to FIG. 3A, a positive offset voltage is applied to a driving circuit, and a reflecting mirror 300 is deflected by +10. Therefore, the reflecting mirror 300 can reflect lights of the light source 310 into the projection lens 330. The lights are finally projected onto a screen, behind the projection lens 330, to form images thereon.

(2) An Image is Vanished (Off Status):

Referring to FIG. 3B, a negative offset voltage is applied to the driving circuit so as to deflect the reflecting mirror 300 by −10. Therefore, lights reflected by the reflecting mirror 300 cannot reach the acquisition range of the projection lens 330 to form an image on the screen behind the projection lens 330.

Every reflecting mirror on the DMD 250 is regards as a pixel, and each pixel is connected to a corresponding memory and a driving circuit. Each memory records a signal of each pixel, and transmits the signal to the driving circuit to deflect the reflecting mirror. Therefore, the lights reflected by the deflected reflecting mirror can form an image on the screen.

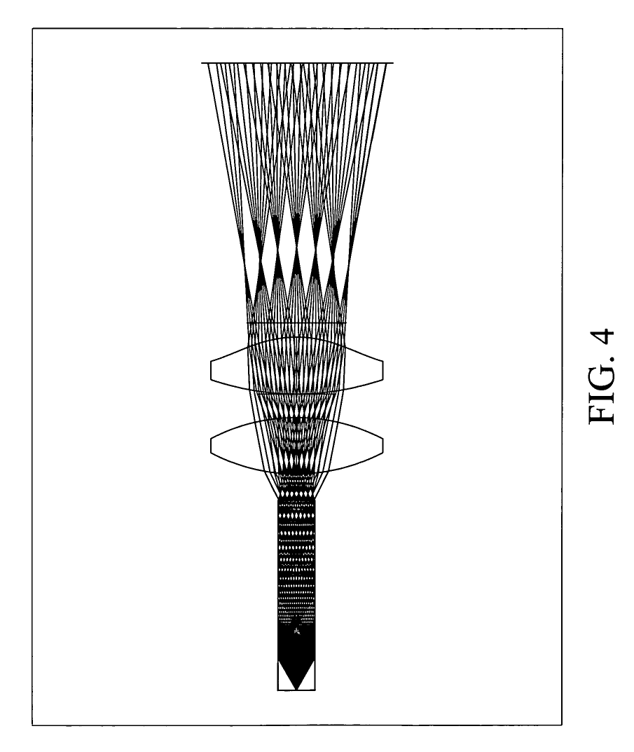

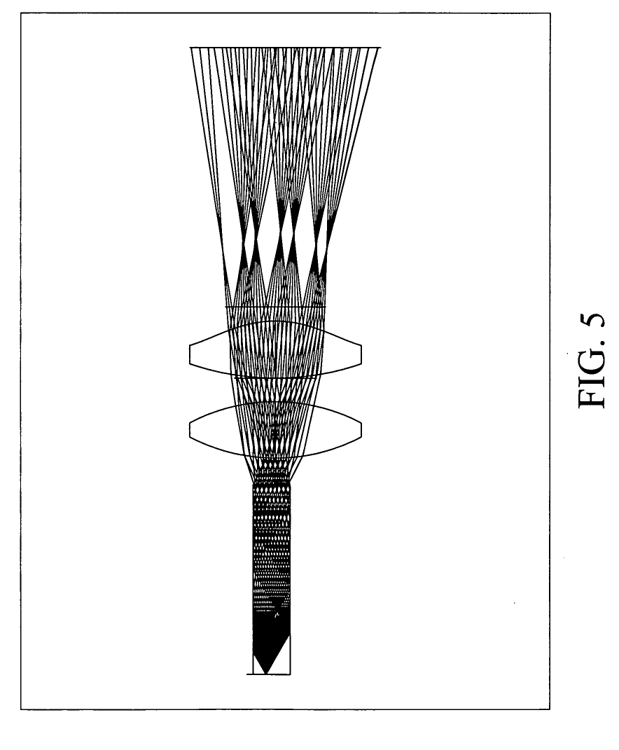

In the conventional projection display devices, the projected lights with a virtual arc array are formed symmetrically, as shown in FIG. 4. Compared to the conventional one, the projection display device in the invention transmits lights with a virtual arc array asymmetrically, as shown in FIG. 5.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A projection display device having an optical system, the optical system comprising:
a light source for emitting lights along a first direction to define an optical axis; and
a light pipe, non-coaxially disposed with the optical axis, receiving the lights from the light source and transmitting lights with a virtual arc array,
wherein the light pipe deviates from the optical axis by a predetermined distance in a second direction perpendicular to the first direction, so that the lights with the virtual arc array is asymmetrical.

2. The device as claimed in claim 1, wherein the predetermined distance is substantially between 0.3 and 0.7 mm.

3. The device as claimed in claim 1, further comprising a convergent lens, positioned between the light source and the light pipe, to focus the lights from the light source to the light pipe.

4. The device as claimed in claim 3, wherein the light pipe comprises a lens module for receiving focused lights transmitted from the convergent lens, and outputting the focused lights uniformly.

5. The device as claimed in claim 1, further comprising a relay lens module and a projection plane, wherein the relay lens module relays the lights from the light pipe to the projection plane.

6. The device as claimed in claim 5, wherein the relay lens module comprises a spherical lens and an aspherical lens.

7. The device as claimed in claim 1, wherein the projection display device is a DLP (digital light processing) projector.

8. The device as claimed in claim 1, wherein the first direction is parallel to an axis on a XY-plane, and the second direction corresponds to a Z-axis.

9. The device as claimed in claim 1, wherein the light pipe deviates oppositely from the light source.
